(19) United States
(12) Patent Application Publication
(10) Pub. No.: US 2017/0082145 A1
(43) Pub. Date: Mar. 23, 2017

(54) SEAL MEMBER, AND ROLLING BEARING FOR WINDMILL MAIN SHAFT

(71) Applicant: JTEKT CORPORATION, Osaka-shi, Osaka (JP)

(72) Inventors: Eisyou HARADA, Yamatotakada-shi (JP); Tomonori KUROKI, Ikoma-gun (JP)

(73) Assignee: JTEKT CORPORATION, Osaka-shi, Osaka (JP)

(21) Appl. No.: 15/123,590

(22) PCT Filed: Feb. 27, 2015
(86) PCT No.: PCT/JP2015/055759

§ 371 Date: Sep. 2, 2016

(30) Foreign Application Priority Data
Mar. 6, 2014 (JP) 2014-043458
Mar. 11, 2014 (JP) 2014-047844

(51) Int. Cl. F16C 33/78; F16C 19/36

(52) U.S. Cl. CPC F16C 33/784; F16C 33/7823; F16C 19/364; F16C 2360/31

(57) ABSTRACT

A seal member is disposed between an inside member and an outside member which rotate relative to each other. The seal member includes: a ring-shaped sliding contact portion which is made of a non-foam rubber and which includes a seal lip slidably contacting one member of the inside member and the outside member; and a body portion which is made of a foam rubber, which includes a ring-shaped joining portion joined to the sliding contact portion, and which contacts the other member of the inside member and the outside member in a radial direction and is fixed to the other member.

### TECHNICAL FIELD

Aspects of the present invention relate to a seal member and a rolling bearing for a windmill main shaft.

### BACKGROUND ART

In wind power generation apparatus, a rolling bearing is used for rotatably supporting a main shaft that is provided with rotary blades for receiving wind power (refer to FIGS. 1-3 of Patent document 1, for example). For example, as shown in FIG. 6, such a rolling bearing 60 is equipped with a circular-ring-shaped seal member 70 for sealing a ring-shaped space S formed between an inner ring 61 and an outer ring 62, whereby entrance of water and dust is prevented into the inside of the bearing in which rollers 63 are contained is prevented. For example, the material of the seal member 70 is a non-foam rubber such as a nitrile rubber (NBR). On the other hand, a seal member made of a foam rubber is disclosed in Patent document 2, for example.

### RELATED ART DOCUMENTS

### Patent Documents

Patent document 1: JP-A-2009-133403

Patent document 2: JP-A-2011-58528 (paragraph [0025] etc.)

### SUMMARY OF THE INVENTION

### Problem to be Solved by the Invention

In recent years, with the size increase of wind power generation apparatus, main shafts that are larger than several meters in diameter have come to be employed and rolling bearings for supporting such large main shafts have also been increased in size. As the rolling bearing 60 has been increased in size, the seal member 70 has also been increased in size and weight, as a result of which the work of setting the seal member 70 between the inner ring 61 and the outer ring 62 has become increasingly difficult. As disclosed in Patent document 2, one countermeasure is to employ a foam rubber in which case the weight of the seal member 70 can be reduced and hence the work of setting the seal member 70 would be made easier. And an additional advantage is expected that the followability to axial deviation of the inner ring 61 is made higher to increase the sealing performance.

However, where the seal member 70 is made of a foam rubber in its entirety, a sliding contact portion 75 (seal lips 76 and 77) which is in sliding contact with an outer circumferential surface 65c of a slinger 65 wears earlier than in the case of a seal member made of a non-foam rubber, which may shorten the life (durable years) of the seal member 70.

Furthermore, since the rolling bearing 60 is installed, for example, on top of a tower of a wind power generation apparatus, work of replacing the seal member 70 cannot be done easily. Still further, in recent years, with the size increase of wind power generation apparatus, the rolling bearing 60 and the seal member 70 which is provided in the rolling bearing 60 have also been increased in size, as a result of which the work of replacing the seal member 70 has become increasingly difficult. Therefore, to lower the frequency of replacement, it is desired to elongate the life of the seal member 70.

Although one measure for elongating the life of the seal member 70 is to change the composition of its rubber material, it does not necessarily provide a sufficient effect. For example, although the employment of a rubber containing graphite or a fluororesin which is superior in wear resistance increases the wear resistance of the seal member 70, it may cause a drawback that the oil resistance of the rubber is lowered to disable enough life elongation. Furthermore, where the rubber material contains graphite or a fluororesin, because of the oleophilicity of NBR, the sliding contact portion 75 itself (seal lips 76 and 77) absorbs oil that enters through the interface between the slinger 65 which is press-fitted with the inner ring 61 and the sliding contact portion 75 which is in sliding contact with the slinger 65, possibly causing an event that the sliding contact portion 75 expands to increase the sliding contact area or deteriorates the rubber, as a result of which the binding ability of the seal member 70 is lowered to degrade its sealing performance.

One aspect of the present invention has been made in view of the above circumstances, and an object thereof is to provide a seal member capable of securing sufficient wear resistance of the sliding contact portion while reducing its weight and increasing its sealing performance, as well as a rolling bearing for a windmill main shaft that is equipped with the seal member.

An object of another aspect of the invention is to provide a seal member capable of securing sufficient sealing performance while elongating its life by virtue of increased wear resistance, as well as a rolling bearing for a windmill main shaft that is equipped with the seal member.

### Means for Solving the Problem

(1) A seal member according to a first aspect of the present invention is a seal member disposed between an inside member and an outside member which rotate relative to each other, the seal member including:

a ring-shaped sliding contact portion which is made of a non-foam rubber and which includes a seal lip slidably contacting one member of the inside member and the outside member; and

a body portion which is made of a foam rubber, which includes a ring-shaped joining portion joined to the sliding contact portion, and which contacts the other member of the inside member and the outside member in a radial direction and is fixed to the other member.

In the seal member according to the first aspect of the invention, since the sliding contact portion including the seal lip slidably contacting the inside member or the outside member is made of a non-foam rubber, the sliding contact portion can be prevented from being lowered in wear resistance unlike in a case that the seal member is made of a foam rubber in its entirety.

Having the ring-shaped joining portion which is made of a form rubber, the seal member according to the first aspect of the invention can contract elastically in the radial direction. Therefore, the followability of the seal member to axial deviation, if any, of the one member relative to the other member can be made higher than that of a seal member that is made of a non-foam rubber in its entirety and hence does not contract elastically. As a result, the sealing performance of the seal member according to the first aspect of the invention can be made higher than that of a seal member that is made of a non-foam rubber in its entirety.

(2) The sliding contact portion may be higher in hardness than the body portion. Where the material of the sliding contact portion is a non-foam rubber that is higher in hardness than the foam rubber for the joining portion, the wear resistance of the sliding contact portion can be made higher than in a case that the sliding contact portion is made of a non-foam rubber that is similar in hardness to the foam rubber for the body portion.

(3) It is preferable that the body portion include a fixing portion which extends in an axial direction and which contacts the other member, that the joining portion include an extension portion which extends from the fixing portion inward in the radial direction, and that the seal lip extend in the axial direction and a base portion of the seal lip be joined to the extension portion. In this case, the radial dimension of the joining portion can be set large, which allows the joining portion to have a great deformation length when it contracts elastically in the radial direction. This makes it possible to further increase the axial deviation followability of the seal member and hence its sealing performance.

(4) It is preferable that a joining interface between the base portion and the extension portion be a surface that is perpendicular to the radial direction. In this case, since the joining interface is perpendicular to the direction of axial deviation of the one member relative to the other member, the extension portion easily deforms elastically.

(5) It is preferable that the body portion include a ring-shaped contact layer which is made of a non-foam rubber and which contacts the other member. Being provided with such a contact layer, the performance of sealing between the seal member and the other member can be made higher than in a case that the seal member is made of a foam rubber in its entirety.

(6) A rolling bearing for a windmill main shaft according to a second aspect of the invention is a rolling bearing for a windmill main shaft which supports a main shaft provided to be integrally rotatable with rotary blades for receiving wind power, the rolling bearing including: an inner ring; an outer ring; a plurality of rolling elements which are rollably disposed in a ring-shaped space formed between the inner ring and the outer ring; and the seal member according to any one of items (1) to (5) which seals the ring-shaped space.

This rolling bearing for a windmill main shaft provides the same advantages as the seal members described in items (1) to (5).

(7) A seal member according to a third aspect of the present invention is a seal member disposed between an inside member and an outside member which rotate relative to each other, the seal member including:

a ring-shaped sliding contact portion which is made of a rubber material and which includes a seal lip slidably contacting one member of the inside member and the outside member; and

a body portion which is made of a rubber material that is lower in hardness than the sliding contact portion, which includes a ring-shaped joining portion joined to the sliding contact portion, and which contacts the other member of the inside member and the outside member in a radial direction and is fixed to the other member.

In the seal member according to the third aspect of the invention, the wear resistance of the sliding contact portion can be increased without the need for having it contain graphite or a fluororesin by forming the sliding contact portion having the seal lip which is in sliding contact with the inside member or the outside member with a rubber material that is high in hardness and can exhibit desired wear resistance.

Since the body portion is made of a rubber material that is lower in hardness than the sliding contact portion, the seal member according to the third aspect of the invention contracts more easily in the radial direction than in a case that the whole of the seal member is made of a rubber material that is high in hardness to increase its wear resistance. As a result, the followability to axial deviation, if any, of the one member relative to the other member can be increased and hence sufficient sealing performance can be secured.

(8) It is preferable that the body portion include a fixing portion which extends in an axial direction and which contacts the other member, that the joining portion include an extension portion which extends from the fixing portion inward in the radial direction, and that the seal lip extend in the axial direction and a base portion of the seal lip be joined to the joining portion. In this case, the radial dimension of the joining portion can be set large, which allows the joining portion to have a wide deformation range when it contracts elastically in the radial direction. This makes it possible to further increase the axial deviation followability of the seal member and hence its sealing performance.

(9) It is preferable that a joining interface between the sliding contact portion and the joining portion be a surface that is perpendicular to the radial direction. In this case, since the joining interface is perpendicular to the direction of axial deviation of the one member relative to the other member, the joining portion easily deforms elastically.

(10) A rolling bearing for a windmill main shaft according to a fourth aspect of the invention is a rolling bearing for a windmill main shaft which supports a main shaft provided to be integrally rotatable with rotary blades for receiving wind power, the rolling bearing including: an inner ring; an outer ring; a plurality of rolling elements which are rollably disposed in a ring-shaped space formed between the inner ring and the outer ring; and the seal member according to any one of items (7) to (9) which seals the ring-shaped space.

This rolling bearing for a windmill main shaft provides the same advantages as the seal members described in items (7) to (9).

### Advantages of the Invention

The seal member and the rolling bearing for a windmill main shaft according to the one aspect of the invention can secure sufficient wear resistance of the sliding contact portion while attaining weight reduction and increase in sealing performance.

The seal member and the rolling bearing for a windmill main shaft according to the another aspect of the invention can secure sufficient sealing performance while realizing life elongation by virtue of increased wear resistance.

### BRIEF DESCRIPTION OF THE DRAWINGS

FIG. 1 is a side view of a wind power generation apparatus which is equipped with a rolling bearing for a windmill main shaft according to an embodiment of the present invention.

FIG. 2 is a sectional view showing a seal member of the above rolling bearing for a windmill main shaft.

FIG. 3 is a side view illustrating a method for placing the seal member.

FIG. 4 is a sectional view showing a seal member according to a first modification of the embodiment.

FIG. 5 is a sectional view showing a seal member according to a second modification of the embodiment.

FIG. 6 is a sectional view of a seal member of a conventional rolling bearing for a windmill main shaft.

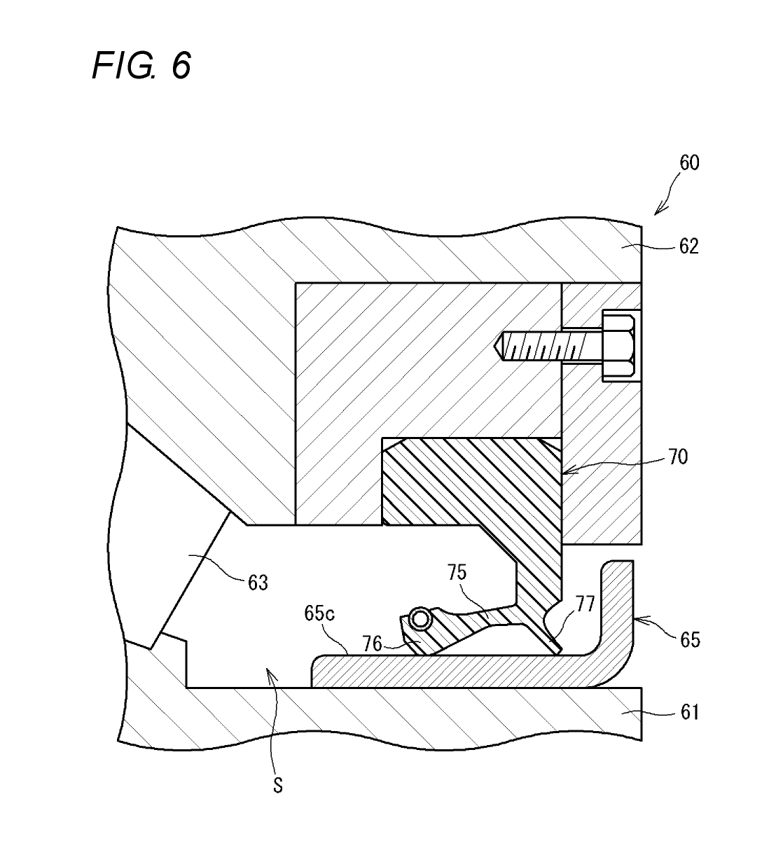

### MODE FOR CARRYING OUT THE INVENTION

A seal member and a rolling bearing for a windmill main shaft according to an embodiment of the present invention will be hereinafter described in detail with reference to the accompanying drawings.

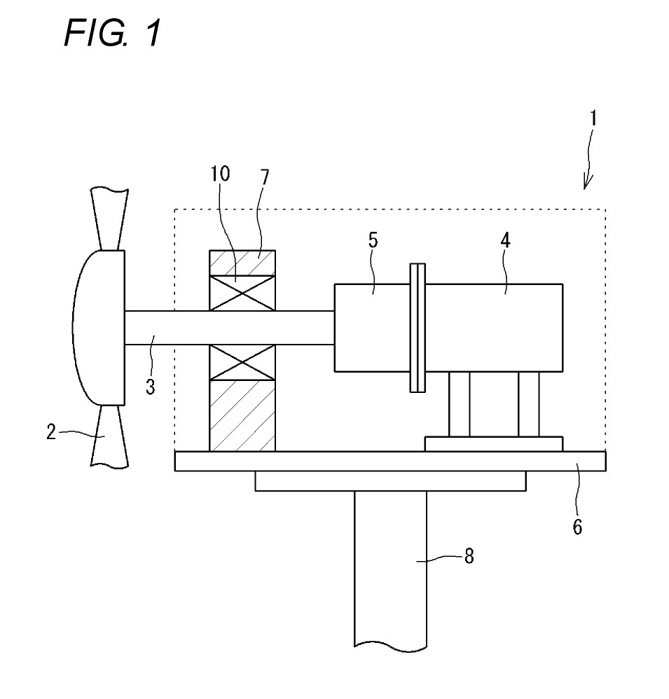

FIG. 1 is a side view of a wind power generation apparatus 1 which is equipped with a rolling bearing 10 for a windmill main shaft according to the embodiment of the invention. As shown in FIG. 1, the wind power generation apparatus 1 is equipped with, on top of a tower 8, a main shaft 3 to one end of which rotary blades 2 for receiving wind power are attached so as to be able to rotate together with it, a generator 4 for generating electric power based on rotational power of the main shaft 3, a speed increaser 5 which couples the main shaft 3 with the input shaft (not shown) of the generator 4, and a support stage 6 which supports the above components. The main shaft 3 is supported rotatably by a rolling bearing (rolling bearing for a windmill main shaft) 10 which is built in a bearing housing 7 erected from the support stage 6.

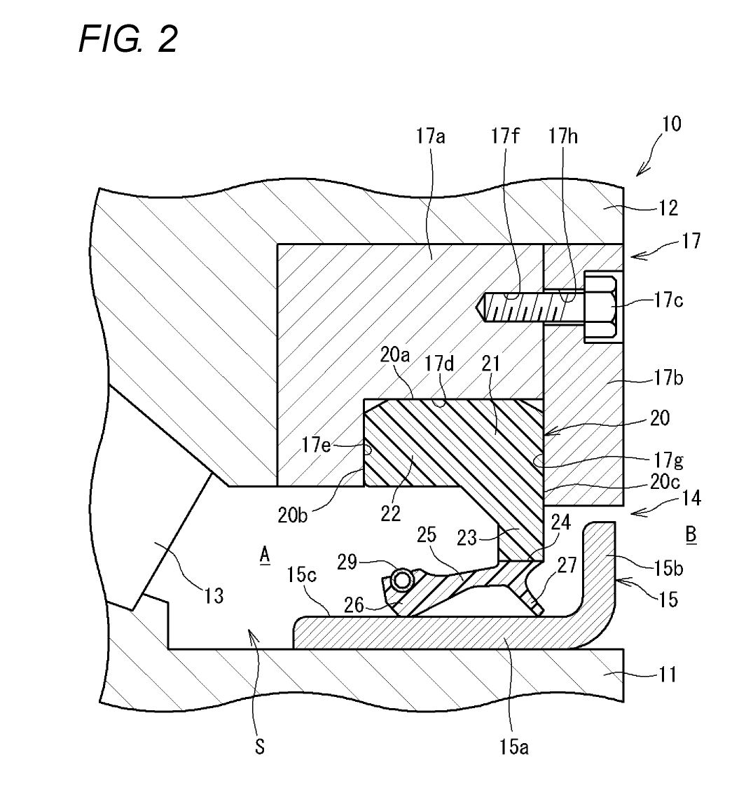

FIG. 2 is a sectional view of a seal member 20 and components neighboring it of the rolling bearing 10. As shown in FIG. 2, the rolling bearing 10, which is a taper roller bearing, is equipped with an inner ring 11, an outer ring 12, plural taper rollers 13 (rolling elements) which are disposed in a ring-shaped space S formed between the inner ring 11 and the outer ring 12 so as to be able to roll, and a sealing device 14 for sealing the ring-shaped space S. The sealing device 14 prevents grease (lubricant) from leaking from the inside A of the rolling bearing 10 to the outside B of it and also prevents foreign matter such as water, dust, etc. from entering the inside A from the outside B.

The sealing device 14 is equipped with a ring-shaped slinger 15 which is press-fitted with the inner ring 11, a ring-shaped seal member 20, and a fixing means 17 for fixing the seal member 20 to the outer ring 12. The slinger 15, which is a ring-shaped metal member that is approximately L-shaped in cross section, has a cylindrical portion 15a which is press-fitted with the inner ring 11 and a ring-shaped portion 15b which is bent outward in the radial direction from the end, adjacent to the outside B, of the cylindrical portion 15a.

The fixing means 17 is equipped with a first holding member 17a and a second holding member 17b for holding the seal member 20 from both sides in the axial direction and fastening bolts 17c as fastening members for fastening the first holding member 17a and the second holding member 17b together.

The first holding member 17a, which is a ring-shaped metal member that is approximately L-shaped in cross section, is fixed to an inner circumferential surface of the outer ring 12 in such a manner as to be press-fitted in it. The first holding member 17a is formed with, as an inner circumferential surface, a sealing surface 17d with which an outer circumferential surface 20a of the seal member 20 is in contact and is also formed with a first holding surface 17e with which an inner side surface 20b of the seal member 20 is in contact. An outer side surface of the first holding member 17a is formed with screw holes 17f with which the fastening bolts 17c are threadedly engaged.

The second holding member 17b, which is a ring-shaped metal plate member, has, inside in the radial direction, a second holding surface 17g which is in contact with an outer side surface 20c of the seal member 20. With the above structure, the seal member 20 is held between the first holding surface 17e of the first holding member 17a and the second holding surface 17g of the second holding member 17b. Through-holes 17h through which the screw portions of the fastening bolts 17c can be inserted penetrate through the second holding member 17b in the axial direction.

The fastening bolts 17c penetrate through the through-holes 17h of the second holding member 17b and are threadedly engaged with the screw holes 17f of the first holding member 17a in a state that the inner side surface of the second holding member 17b is in contact with the outer side surface of the first holding member 17a. As a result, the seal member 20 is held between the first holding member 17a and the second holding member 17b.

The seal member 20 is held between the first holding member 17a and the second holding member 17b, and has a body portion 21 which is in contact with the sealing surface 17d of the first holding member 17a in the radial direction and is thereby fixed to it and a sliding contact portion 25 which is joined to the body portion 21 and is in sliding contact with the cylindrical portion 15a of the slinger 15. The seal member 20 is a large one that is larger than or equal to, for example, 1,500 mm in diameter.

The body portion 21 includes a fixing portion 22 which extends in the axial direction and is in contact with the sealing surface 17d of the first holding member 17a and an extension portion (joining portion) 23 which extends from the fixing portion 22 inward in the radial direction. The fixing portion 22 is approximately shaped like a long and narrow rectangle in cross section with its width being in the radial direction and is also in contact with the first holding surface 17e and the second holding surface 17g. The extension portion 23 extends from an outside end portion, in the axial direction, of the fixing portion 22.

The sliding contact portion 25 is joined to an end portion, inside in the radial direction, of the extension portion 23. A joining interface 24 between the sliding contact portion 25 and the extension portion 23 is cylindrical and perpendicular to the radial direction. The sliding contact portion 25 includes a main lip 26 and a sub-lip 27 which are disposed inside the extension portion 23 in the radial direction and arranged in the axial direction.

The main lip 26, which serves to prevent leakage of grease from the inside A to the outside B, extends from the joining interface 24 toward the inside A (i.e., inward in the axial direction) and is in sliding contact with an inside A of the outer circumferential surface 15c of the cylindrical portion 15a. The main lip 26 is formed with a ring-shaped gutter in a tip portion at an outside position in the radial direction, and a gutter spring 29 is fitted in the ring-shaped gutter. The gutter spring 29 pushes the main lip 26 inward in the radial direction. The sub-lip 27, which serves to prevent entrance of foreign matter into the inside A, extends from the joining interface 24, branches off the main lip 26, and extends toward the outside B (i.e., outward in the axial direction) and inward in the radial direction so as to be in sliding contact with an outside B of the outer circumferential surface 15c of the cylindrical portion 15a.

The radial dimension of the extension portion 23 is approximately equal to that of the fixing portion 22 and larger than that of the sliding contact portion 25.

The body portion 21 and the sliding contact portion 25 are formed by extrusion molding using two independent twin-screw extruders and then joined together by vulcanization molding while being kept straight. Where they are made of the same type of rubber, they are joined together directly by vulcanization bonding. On the other hand, where they are made of different types of rubber, they are joined together by vulcanization bonding after, for example, applying paste-like unvulcanized rubber produced by blending the different rubber materials to their joining surfaces.

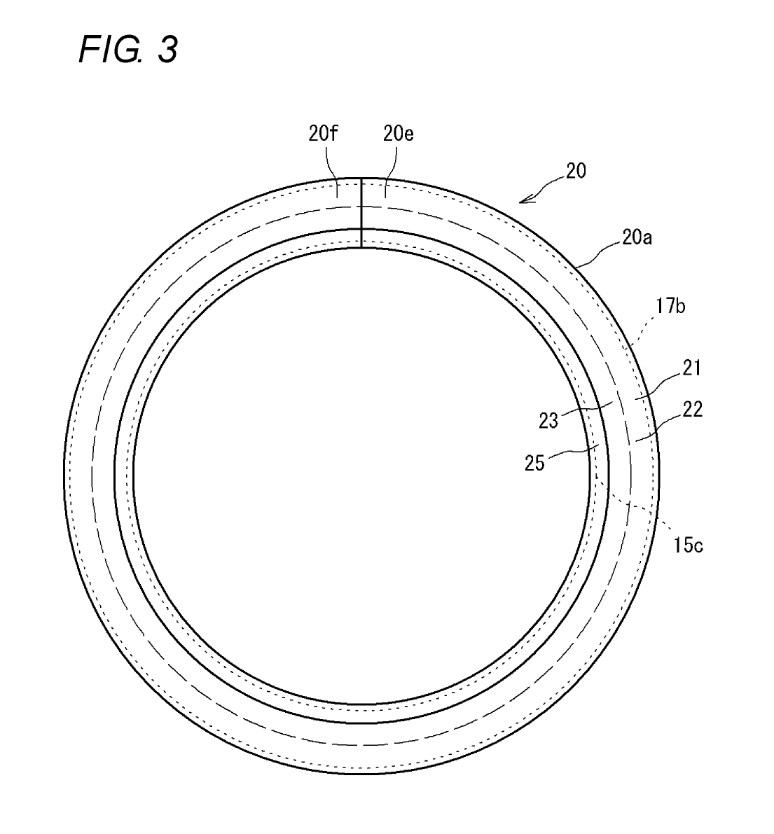

FIG. 3 is a side view illustrating a method for placing the seal member 20 between the outer circumferential surface 15c of the slinger 15 and the sealing surface 17d of the first holding member 17a. The seal member 20 is formed so that before its placement the diameter of the outer circumferential surface 20a is somewhat longer than that of the sealing surface 17d as shown in FIG. 3. Furthermore, the seal member 20 is formed so that before its placement its radial dimension (width) is somewhat larger than that between the outer circumferential surface 15c and the sealing surface 17d. The seal member 20 is placed between the outer circumferential surface 15c and the sealing surface 17d by pushing it into place while bending the seal member 20 (which is straight originally) into a ring shaped and bringing its two end portions 20e and 20f into contact with each other in the circumferential direction, and compressing the joining portion 23 in the radial direction. Placed in this manner, the seal member 20 pushes the sealing surface 17d outward in the radial direction and is fixed so as not to rotate relative to the outer ring 12. Thus, the seal member 20 follows axial deviation of the inner ring 11 relative to the outer ring 12.

(First Example Set of Seal Member Materials)

In a first example set of seal member materials, the body portion 21 is made of a fine foam type (closed cell type) foam rubber in its entirety. On the other hand, the sliding contact portion 25 is made of a non-foam rubber in its entirety. For example, each of the foam rubber and the non-foam rubber may be a synthetic rubber such as a nitrile rubber (NBR), a hydrogenated nitrile butadiene rubber (HNBR), or a fluororubber (FKM) or a natural rubber (NR). The hardness of the non-foam rubber for the sliding contact portion 25 is set higher than that of the foam rubber for the body portion 21. More specifically, in terms of durometer harness as defined in JIS K6253, the hardness of the non-foam rubber is set at about A70, for example, and the hardness of the foam rubber is set at about A50, for example. The foam rubber and the non-foam rubber may be either the same type of rubber or different types of rubber.

(Second Example Set of Seal Member Materials)

In a second example set of seal member materials, the body portion 21 and the sliding contact portion 25 are both made of a non-foam rubber material. For example, this rubber material may be a synthetic rubber such as a nitrile rubber (NBR), a hydrogenated nitrile butadiene rubber (HNBR), or a fluororubber (FKM) or a natural rubber (NR). The sliding contact portion 25 is made of a rubber material that is high in hardness and can exhibit desired wear resistance. On the other hand, the body portion 21 is made of a rubber material that is lower in hardness than the material of the sliding contact portion 25 and easily deforms elastically. For example, a rubber material whose durometer harness as defined in JIS K6253 is equal to about A65 to A70 can be used for the sliding contact portion 25 and a rubber material whose durometer harness as defined in JIS K6253 is lower than the rubber material for the sliding contact portion 25 and is equal to about A50 to A55 can be used for the body portion 21. The rubber material for the body portion 21 and that for the sliding contact portion 25 may be either the same type of rubber or different types of rubber.

As described above, in the seal member 20 according to the first example of the embodiment, since the sliding contact portion 25 is made of a non-foam rubber, the sliding contact portion 25 can be prevented from being lowered in wear resistance unlike in a case that the seal member 20 is made of a foam rubber in its entirety.

Since the extension portion 23 of the seal member 20 is made of a form rubber, it can contract elastically in the radial direction through volume reduction of bubbles contained in the foam rubber. Therefore, the followability of the seal member 20 to axial deviation, if any, of the inner ring 11 relative to the outer ring 12 can be made higher than that of a non-contractible seal member that is made of a non-foam rubber in its entirety. As a result, the sealing performance of the seal member 20 can be made higher than that of a seal member that is made of a non-foam rubber in its entirety.

Furthermore, since the non-foam rubber for the sliding contact portion 25 is higher in hardness than the foam rubber for the body portion 21, the wear resistance of the sliding contact portion 25 can be made higher than in a case that the sliding contact portion 25 is made of a non-foam rubber that is similar in hardness to the foam rubber for the body portion 21.

In the seal member 20 according to the second example of the embodiment, the wear resistance of the sliding contact portion 25 can be increased without the need for having it contain graphite or a fluororesin because the sliding contact portion 25 which is in sliding contact with the slinger 15 and includes the main lip 26 and sub-lip 27 is made of a rubber material that is high in hardness and can exhibit desired wear resistance.

In the embodiment (first and second examples), the width of the fixing portion 22 is in the radial direction, the extension portion 23 extends from the fixing portion 22 inward in the radial direction, the main lip 26 extends in the axial direction, and a base portion 25a of the main lip 26 (and the sub-lip 27) is joined to the extension portion 23. Therefore, the radial dimension of the extension portion 23 (an example of the joining portion; in the first example, it is made of a foam rubber) can be set large, which allows the extension portion 23 to have a great deformation length when it contracts elastically in the radial direction. This makes it possible to further increase the axial deviation followability of the seal member 20 and hence its sealing performance.

Since the joining interface 24 is a plane that is perpendicular to the radial direction, that is, to the direction of axial deviation of the inner ring 11 relative to the outer ring 12, the extension portion 23 easily deforms elastically.

It is possible to lower the material cost while securing desired performance by using, for the sliding contact portion 25, HNBR which is superior in heat resistance and weatherability, FKM which is superior in heat resistance, wear resistance, and weatherability, or the like and using, for the body portion 21, a rubber that is less expensive than HNBR and FKM, such as NBR or NR.

Furthermore, by forming the seal member 20 by extrusion molding, no die manufacturing cost etc. are necessary unlike in a case of employing molding that uses a ring-shaped die. The molding cost can be lowered accordingly.

Modifications

The invention is not limited to the above embodiment but can be practiced by modifying the embodiment as appropriate. Differences, from the embodiment, of modifications of the embodiment will be described below.

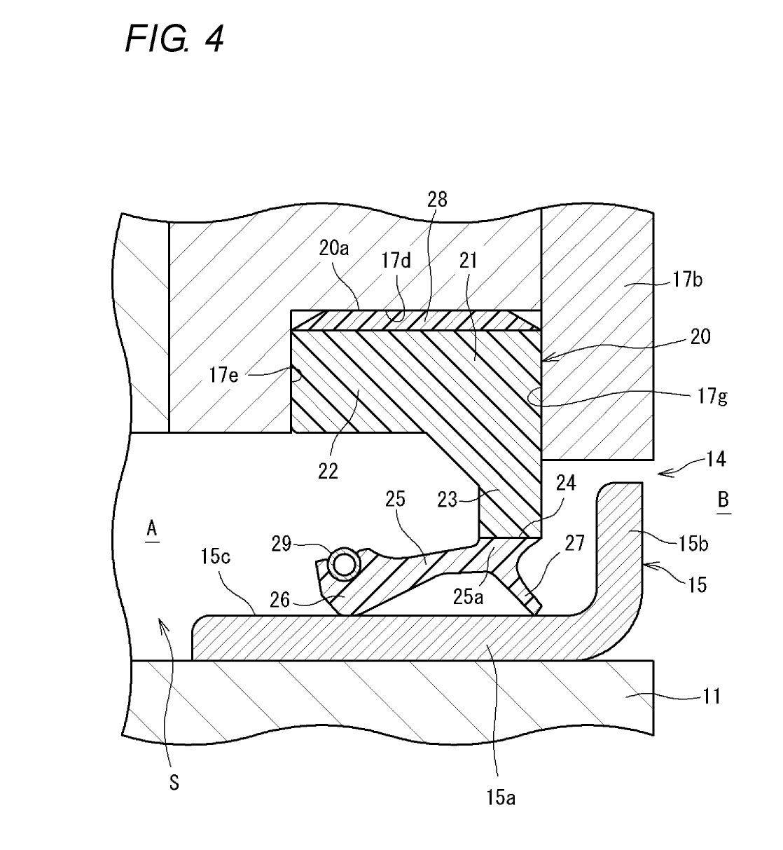

FIG. 4 shows a seal member 20 according to a first modification. For example, the first modification is applicable to the first example of the embodiment. As shown in FIG. 4, a cylindrical contact layer 28 which is made of a non-foam rubber is disposed outermost side the body portion 21 of the seal member 20 in the radial direction so as to be in contact with the sealing surface 17d. Unlike in the embodiment in which the body portion 21 is in direct contact with the sealing surface 17d (see FIG. 2), in the first modification the body portion 21 is in contact with the sealing surface 17d indirectly, that is, via the contact layer 28. The thickness (radial dimension) of the contact layer 28 is about 1 to 2 mm. The non-foam rubber for the contact layer 28 may be NBR, HNBR, FKM, or the like, and a proper material can be selected taking the material cost and a use environment of the rolling bearing 10 into consideration. For example, the hardness of the non-foam rubber of the contact layer 28 may be set similar to that of the sliding contact portion 25 (in the above-described example, about A70).

The contact layer 28 is formed in band form by extrusion molding using a twin-screw extruder and then joined to the body portion 21 by vulcanized molding at the same time as the extension portion 23 and the sliding contact portion 25 are joined together.

In the seal member 20 shown in FIG. 4, since the ring-shaped contact layer 28 which is made of a non-foam rubber is disposed outermost side the body portion 21 in the radial direction so as to be in contact with the sealing surface 17d, the performance of sealing between the seal member 20 and the sealing surface 17d can be made higher than in a case that the seal member 20 is made of a foam rubber in its entirety. Although the seal member 20 may slide relative to the sealing surface 17d, in this modification an outermost portion of the seal member 20 is prevented from wearing due to such a slide because of the employment of the contact layer 28 made of a non-foam rubber.

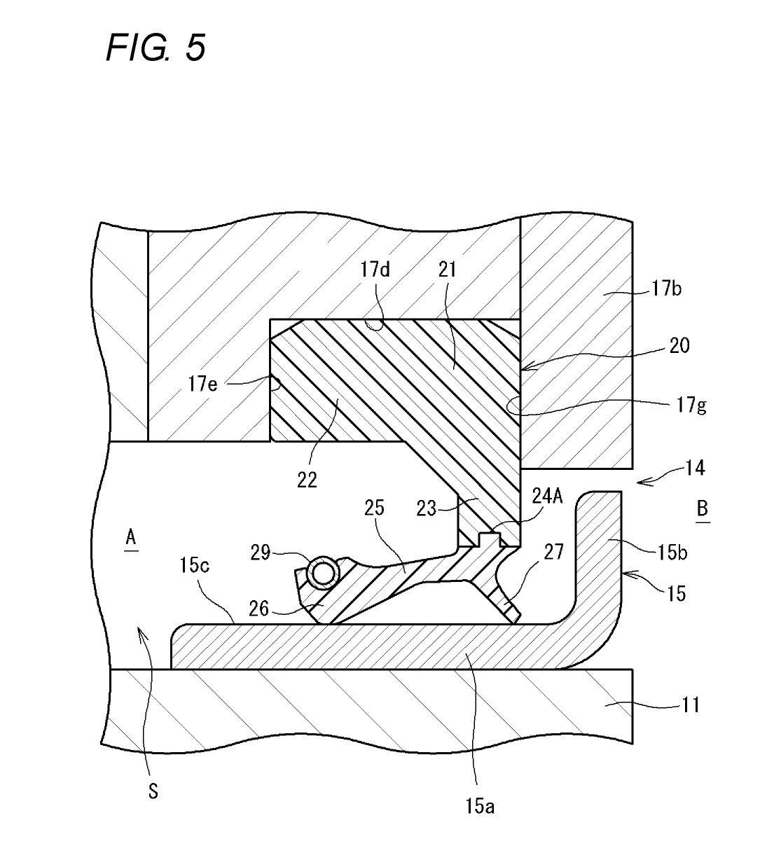

FIG. 5 shows a seal member 20 according to a second modification. For example, the second modification is applicable to the first example and the second example of the embodiment. As shown in FIG. 5, a joining interface 24A between the extension portion 23 and the sliding contact portion 25 of the seal member 20 is undulated. In the extension portion 23 and the sliding contact portion 25, whereas a tip portion of the extension portion 23 is formed with a recess when the body portion 21 is formed by extrusion molding, a base portion 25a of the main lip 26 (and the sub-lip 27) is formed with a projection when the sliding contact portion 25 is formed by extrusion molding. Then the tip portion of the extension portion 23 and the base portion 25a are bonded to each other by vulcanized molding with the projection fitted into the recess.

In the seal member 20, since the joining interface 24A is undulated, the area of contact between the body portion 21 and the sliding contact portion 25 can be made larger than in the case that the joining interface is flat, whereby the joining can be made stronger.

Incidentally, the rolling bearing 10 may be configured in such a manner that the sliding contact portion 25 is in direct sliding contact with the outer circumferential surface of the inner ring 11 or that the body portion 21 is in direct contact with the inner circumferential surface of the outer ring 12 in the radial direction and is thereby fixed to the latter. Furthermore, when the seal member 20 is placed between the outer circumferential surface 15c of the slinger 15 and the sealing surface 17d of the first holding member 17a, the two end portions 20e and 20f of the seal member 20 may be bonded to each other with an epoxy resin.

The present application is based on Japanese Patent Application No. 2014-043458 filed on Mar. 6, 2014 and No. 2014-047844 filed on Mar. 11, 2014, the disclosures of which are incorporated herein by reference.

### DESCRIPTION OF REFERENCE SIGNS

2: Rotary Blades; 3: Main shaft; 10: Rolling Bearing (Rolling Bearing for Windmill Main Shaft); 11: Inner Ring (Inside Member); 12: Outer Ring (Outside Member); 13: Taper Roller (Rolling Body); 15: Slinger (Inside Member); 17a: First Holding Member (Outside Member); 20: Seal Member; 21: Body Portion; 23: Extension Portion (Joining Portion); 24: Joining Interface; 24A: Joining Interface; 25: Sliding Contact Portion; 25a: Base Portion; 26: Main Lip (Seal Lip); 28: Contact Layer; S: Ring-Shaped Space

1. A seal member disposed between an inside member and an outside member which rotate relative to each other, said seal member comprising:
a ring-shaped sliding contact portion which is made of a non-foam rubber and which comprises a seal lip slidably contacting one member of the inside member and the outside member; and
a body portion which is made of a foam rubber, which comprises a ring-shaped joining portion joined to the sliding contact portion, and which contacts the other member of the inside member and the outside member in a radial direction and is fixed to the other member.

2. The seal member according to claim 1,
wherein the sliding contact portion is higher in hardness than the body portion.

3. The seal member according to claim 1,
wherein the body portion comprises a fixing portion which extends in an axial direction and which contacts the other member,
wherein the joining portion comprises an extension portion which extends from the fixing portion inward in the radial direction, and
wherein the seal lip extends in the axial direction, and a base portion of the seal lip is joined to the extension portion.

4. The seal member according to claim 3,
wherein a joining interface between the base portion and the extension portion is a surface that is perpendicular to the radial direction.

5. The seal member according to claim 1,
wherein the body portion comprises a ring-shaped contact layer which is made of a non-foam rubber and which contacts the other member.

6. A rolling bearing for a windmill main shaft which supports a main shaft provided to be integrally rotatable with rotary blades for receiving wind power, said rolling bearing comprising:
an inner ring;
an outer ring;
a plurality of rolling elements which are rollably disposed in a ring-shaped space formed between the inner ring and the outer ring; and
the seal member according to claim 1 which seals the ring-shaped space.

7. A seal member disposed between an inside member and an outside member which rotate relative to each other, said seal member comprising:
a ring-shaped sliding contact portion which is made of a rubber material and which comprises a seal lip slidably contacting one member of the inside member and the outside member; and
a body portion which is made of a rubber material that is lower in hardness than the sliding contact portion, which comprises a ring-shaped joining portion joined to the sliding contact portion, and which contacts the other member of the inside member and the outside member in a radial direction and is fixed to the other member.

8. The seal member according to claim 7,
wherein the body portion comprises a fixing portion which extends in an axial direction and which contacts the other member,
wherein the joining portion comprises an extension portion which extends from the fixing portion inward in the radial direction, and
wherein the seal lip extends in the axial direction, and a base portion of the seal lip is joined to the extension portion.

9. The seal member according to claim 7,
wherein a joining interface between the sliding contact portion and the joining portion is a surface that is perpendicular to the radial direction.

10. A rolling bearing for a windmill main shaft which supports a main shaft provided to be integrally rotatable with rotary blades for receiving wind power, said rolling bearing comprising:
an inner ring;
an outer ring;
a plurality of rolling elements which are rollably disposed in a ring-shaped space formed between the inner ring and the outer ring; and
the seal member according to claim 7 which seals the ring-shaped space.

11. The seal member according to claim 2,
wherein the body portion comprises a fixing portion which extends in an axial direction and which contacts the other member,
wherein the joining portion comprises an extension portion which extends from the fixing portion inward in the radial direction, and
wherein the seal lip extends in the axial direction, and a base portion of the seal lip is joined to the extension portion.

12. The seal member according to claim 2,
wherein the body portion comprises a ring-shaped contact layer which is made of a non-foam rubber and which contacts the other member.

13. The seal member according to claim 3,
wherein the body portion comprises a ring-shaped contact layer which is made of a non-foam rubber and which contacts the other member.

14. The seal member according to claim 4,
wherein the body portion comprises a ring-shaped contact layer which is made of a non-foam rubber and which contacts the other member.

15. The seal member according to claim 11,
wherein the body portion comprises a ring-shaped contact layer which is made of a non-foam rubber and which contacts the other member.

16. The seal member according to claim 8,
wherein a joining interface between the sliding contact portion and the joining portion is a surface that is perpendicular to the radial direction.
